(19) United States
(12) Patent Application Publication
(10) Pub. No.: US 2008/0233780 A1
(43) Pub. Date: Sep. 25, 2008

(54) Power socket having illuminated plug receiving apertures

(76) Inventors: Darrell Waters, Fountain Valley, CA (US); Angel Waters, Fountain Valley, CA (US); Daniel Waters, Playa Del Rey, CA (US)

Correspondence Address: JAMES RAY & ASSOCIATES, 2640 PITCAIRN ROAD, MONROEVILLE, PA, 15146, US

(21) Appl. No.: 11/726,549

(22) Filed: Mar. 22, 2007

(51) Int. Cl. H01R 4/58

(52) U.S. Cl. 439/214

(57) ABSTRACT

The present invention provides an electrical power socket having illuminated prong receiving apertures. A light source, such as a light emitting diode, is mounted within the power socket and is operatively connected to a voltage converter capable of converting supply AC voltage into operating DC voltage. A switch or ambient light sensor may be provided for selectively operating the light source. The power socket may be used with a wall mounted power outlet, power strip or power extension cord.

### CROSS-REFERENCE TO RELATED APPLICATIONS

This application is related to and claims priority from Provisional Patent Application Ser. No. 60/784,285 filed Mar. 22, 2006.

### FIELD OF THE INVENTION

The present invention relates, in general, to power sockets and, more particularly, this invention relates to a power socket for use with an electrical outlet, power strip, extension cord and the like and which employs a light source for illuminating its prong receiving apertures.

### BACKGROUND OF THE INVENTION

It is generally well known that many situations require use of an electrical power outlet or electrical power strip device. Often, these devices are located behind furniture or in an area of reduced visibility making it difficult for the user to locate them. Particular difficulty arises when the user must locate these devices during darkness or nightfall conditions often resorting to a method of manually touching the device in order to determine proper orientation of prong receiving apertures. Such method exposes the user to unnecessary safety risks. Furthermore, the user must remember the orientation and location of apertures when plugging in a power cord plug.

Efforts have been made to alleviate difficulties of locating power outlet or power strip receptacles during periods of darkness or nightfall conditions.

U.S. Pat. No. 7,011,422 issued to Robertson et al. and U.S. Pat. No. 5,277,620 issued to Taylor disclose a light permeable housing for a power outlet and power strip respectively, which is capable of illuminating light therethrough and wherein a light source is disposed within the housing. However, it has been perceived that such prior art permeable housing illuminates a greater than desired quantity of light.

### SUMMARY OF THE INVENTION

In accordance with one embodiment, the present invention provides an improved power socket having a base portion, a plurality of conductors which are mounted within the base portion and which are connectable to a source of power, a seat portion having a plurality of receiving apertures each disposed in alignment with a respective conductor for receiving a pin or blade of a power plug and a light means for illuminating at least one receiving aperture.

In accordance with another embodiment of the present invention, there is provided an improved electrical power outlet including a non-conductive body member having an electrical receptacle means which is connectable to a source of power, a non-conductive cover secured to the body member and having a plurality of receiving apertures operatively aligned with the electrical receptacle means and a light means which is disposed internally within the power outlet for illuminating at least one receiving aperture.

In accordance with yet another embodiment, the invention provides an improved electrical power strip having a generally elongated housing, a plurality of electrical power sockets mounted within the housing, a cord which is operatively connected to each of the plurality of electrical power sockets and which is equipped with prongs for connecting the electrical power strip to supply voltage means and a light means for illuminating at least one receiving aperture disposed within at least one of the plurality of electrical power sockets.

### OBJECTS OF THE INVENTION

It is, therefore, one of the primary objects of the present invention to provide a power socket having a light source for illuminating prong receiving apertures.

Another object of the present invention is to provide a power socket having illuminated prong receiving apertures wherein the light source is positioned within the socket.

Yet another object of the present invention is to provide a power socket having illuminated prong receiving apertures wherein AC supply voltage is converted into DC operating voltage.

A further object of the present invention is to provide a power socket having illuminated prong receiving apertures which employs means for selective control of the light source operation.

Yet a further object of the present invention is to provide a power socket having illuminated prong receiving apertures which are simple and inexpensive to manufacture.

An additional object of the present invention is to provide a power socket having illuminated prong receiving apertures which can be used with any conventional electrical power connecting device.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a power socket of the present invention mounted within a power outlet;

FIG. 2 is a block diagram of the power socket of FIG. 1;

FIG. 3 is a perspective view of a power strip employing the power socket of the present invention; and

FIG. 4 is a perspective view of an extension cord employing the power socket of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

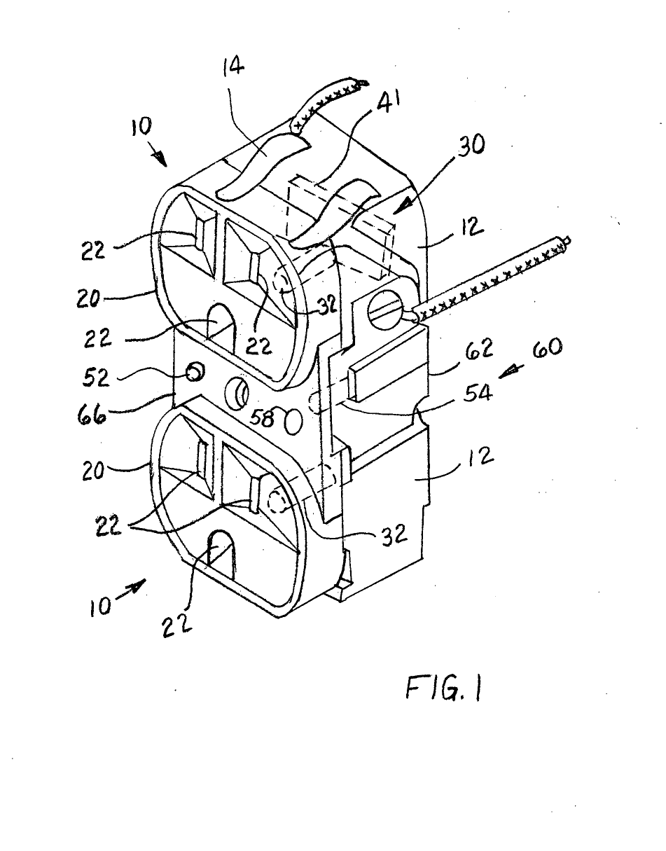

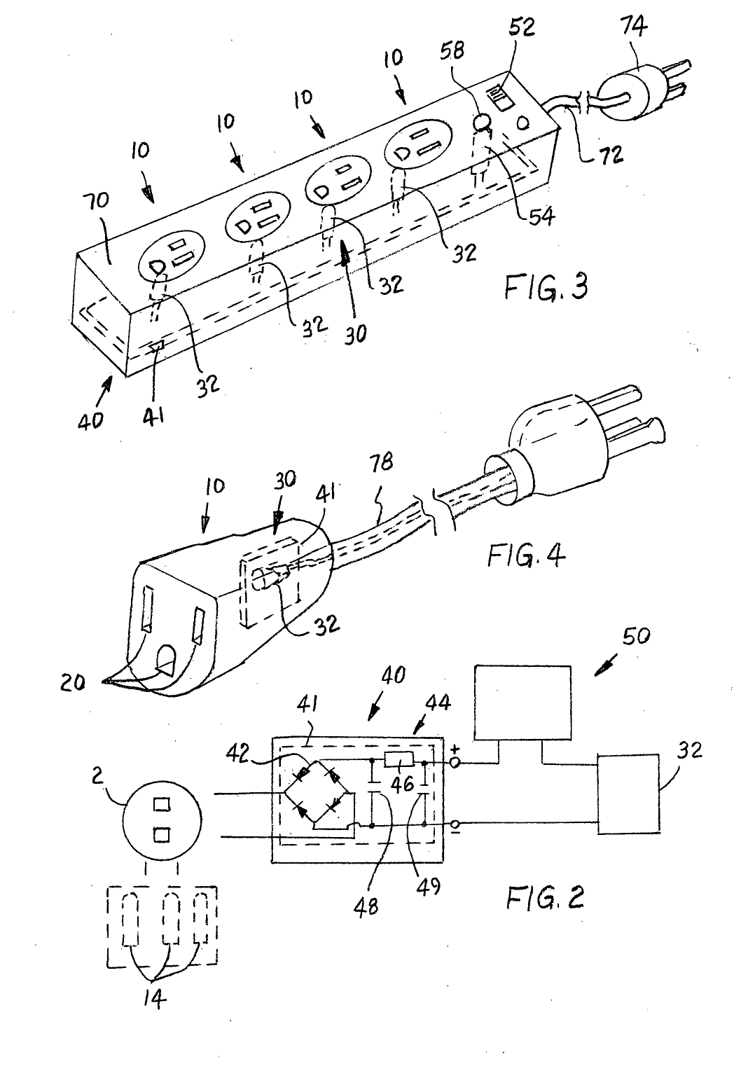

Reference is now made, to FIGS. 1-4, wherein there is shown a power socket, generally designated 10, having illuminated prong receiving apertures. Such power socket 10 is typically mounted within an electrical power outlet, power strip, extension cord and the like.

By way of an example only, the details of the present invention will be illustrated in combination with a wall mounted electrical power outlet, generally designated 60.

Briefly, the power socket 10 has a base portion 12. A plurality of conductors 14 are mounted within the base portion 12 in a spaced relationship therebetween and are generally connected to a power source 2 for receiving supply power therefrom. As it is well known, such supply power is generally a voltage which is characterized by an alternating current. A seat portion 20 abuts the base portion 12 and has a plurality of receiving apertures 22 which are disposed in alignment with a respective conductor 14 for receiving a prong, such as a blade or a pin, of a power plug (not shown) in a conventional fashion. For the sake of brevity, all prong receiving apertures are labeled as 20 even though shape of each aperture will be based on the shape and functionality of the respective prong (not shown). It will be appreciated that a standard 3-prong arrangement as used in the US is illustrated in various Figures. Both the base portion 12 and the seat portion 20 are made from a non-permeable material used in existing power sockets.

A light means, generally designated 30, is provided for illuminating prong receiving apertures 22 of the power socket 10. The light means 30 includes at least one light source 32 which is positioned within the base portion 12 and which is operable upon supply of an operating voltage. Preferably, the at least one light source 32 is of a well known light emitting diode (LED) type.

It will be understood that the position of the at least one light source 32 will depend on the construction and type of the power socket 10. For example, when the power socket 10 includes three conductors 14, it has been found that such light source 32 can be simply positioned generally centrally to and intermediate the trio of conductors 14.

A control means, generally designated 40, is provided for converting the supply voltage into the operating voltage and for supplying the operating voltage to at least one light source 32, being such LED. The control means 40 generally includes a bridge rectifier means 42 in electrical communication with the power source 2 and a voltage regulating and conditioning means, generally designated 44, in electrical communication with the bridge rectifier 42 and the at least one light source 32. The voltage regulating and conditioning means 44 may simply include an IC regulator 46 and a pair of capacitors 48 and 49. It will be appreciated that the at least one light source 32, the bridge rectifier means 42 and the voltage regulating and conditioning means 44 are preferably mounted on a well known printed circuit board (PCB) member 41.

In operation, when the at least one light source 32 is the LED, the control means 40 simply converts the supply voltage which is generally characterized by the alternating current into the operating voltage of a direct current type. Accordingly, the at least one light source 32 is activated due to the supply of this operating current and illuminates the prong receiving apertures 22. Therefore, such power socket 10 having illuminated prong receiving apertures 22 is easily located during darkness or night fall conditions.

It will be appreciated that the brightness of the at least one light source 32 can be selected to provide a desired level of illumination. By way of an example only, a 20 ma, 3 VDC LED from Linrose Electronics of Plainview, N.Y. has been found to provide sufficient illumination of the prong receiving apertures 22 in a manner that would not interrupt sleep and would not be obtrusive to users of such power socket 10. Furthermore, the color of the at least one light source 32 can be selected based on user preference.

The present invention contemplates that it may be desirable to selectively operate the at least one light source 32 in accordance with user preference or daylight conditions and, accordingly, the present invention provides a switch means, generally designated 50, which is coupled to control means 40.

According to one embodiment of the invention, the switch means 50 includes a manually operated selector switch 52 which is preferably operable from the exterior surface of the power socket 10.

According to another embodiment of the invention, the switch means 50 includes an ambient light sensor 54 for sensing an ambient light and for selectively operating the at least one light source 32 in response to the sensed ambient light. The ambient light sensor 54 may be of any well known type, including but not limited to photo resistor, photo diode, photo transmitter, photo diode in combination with current amplifier and the like. Such ambient light sensor 54 may be positioned within the base portion 12 and further positioned behind an aligned permeable portion 58 disposed in the seat portion 20.

It will be understood that the power outlet 60 will employ a pair of power sockets 10. The power outlet 60 is formed by a base member 62 which essentially incorporates two base portions 12. The base member 62 is employed for mounting two sets of conductors 14. A common cover member 66 is secured to the base member 62 and has two sets of receiving apertures 22 in alignment with the conductors 14.

In such embodiment, it is presently preferred to employ a pair of light sources 32, wherein each light source 32 is positioned relative to each set of conductors 14. Both light sources 32 are connected to the common control means 40 which may be mounted internal or external to the base member 62 based on the available space. Although it will be appreciated that a pair of control means connected to the source of supply power may be utilized. When employed, the ambient light sensor 54 may be advantageously mounted intermediate the pair of power sockets 10. It is further contemplated to provide such manually operable switch 52 either independently from or in combination with the ambient light sensor 54.

By way of another example of FIG. 3, a plurality of power sockets 10 are mounted within a well known power strip 70 having a cord 72 and a plug 74 for connection to the power source such as the power outlet 60.

By way of yet another example of FIG. 4, the power socket 10 is integrated into one end of an extension cord 78.

It will be apparent to those skilled in the art, that use of the at least one light source 32 positioned to illuminate prong receiving apertures of various embodiments of the present invention enables ease of identifying location of the power socket 10 during nightfall or dark conditions while permitting use of present materials which do not permeate light therethrough. It will be appreciated that the condition of illuminating prong receiving apertures from inside the power socket 10 minimizes the visible light external to the power socket 10 and minimizes intrusion of this visible light into the operating environment while providing for sufficient identification of the power socket 10 during such nightfall or dark conditions.

Although the present invention has been shown in terms of the light source 32 being the well known LED, it will be apparent to those skilled in the art, that the present invention may be applied to other light source types.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

1. In combination with a power socket having a light non-permeable base portion, a plurality of conductors mounted within said base portion and connectable to a source of power, a seat portion having a plurality of receiving apertures each disposed in alignment with a respective conductor for receiving a pin or blade of a power plug, an improvement comprising a light means for illuminating at least one receiving aperture from within said power socket.

2. The improvement, according to claim 1, wherein said light means includes:
(a) at least one light source which is positioned internally within said base portion and intermediate said plurality of conductors, said at least one light source operable upon supply of an operating voltage; and
(b) a control means for converting said supply voltage into said operating voltage and for supplying said operating voltage to said at least one light source.

3. The improvement, according to claim 2, wherein said at least one light source includes a light emitting diode.

4. The improvement, according to claim 3, wherein said improvement includes a switch means operatively coupled to said control means and to said at least one light source for selectively operating said at least one light source.

5. The improvement, according to claim 4, wherein said switch means includes a manually operated selector switch.

6. The improvement, according to claim 5, wherein said selector switch is manually operable from an exterior surface of said power socket.

7. The improvement, according to claim 4, wherein said switch means includes an ambient light sensor for sensing an ambient light and for selectively operating said at least one light source in response to said sensed ambient light.

8. The improvement, according to claim 7, wherein said ambient light sensor is positioned within said base member and behind a permeable portion disposed in an aligned relationship within said seat portion.

9. The improvement, according to claim 2, wherein said power socket includes three receiving apertures and said at least one light illuminates each receiving aperture.

10. The improvement, according to claim 1, wherein said improvement includes a switch means operatively disposed within said power socket for selectively operating said light means.

11. The improvement, according to claim 1, wherein said power socket is disposed within a wall mounted power outlet.

12. The improvement, according to claim 1, wherein said power socket is disposed within a power strip.

13. The improvement, according to claim 1, wherein said power socket is disposed within one end of an extension cord.

14. In combination with an electrical power outlet including a non-conductive light non-permeable body member having an electrical receptacle means which is connectable to a source of power and a non-conductive light non-permeable cover secured to said body member and having a plurality of receiving apertures operatively aligned with said electrical receptacle means, an improvement comprising a light means which is disposed internally within said power outlet for illuminating at least one receiving aperture, said light means including at least one light source mounted within said electrical receptacle means and intermediate a plurality of conductors thereof, said at least one light source operable upon supply of an operating voltage and a control means for converting said supply voltage into said operating voltage and for supplying said operating voltage to said at least one light source.

15. The improvement, according to claim 14, wherein said improvement further includes a switch means operatively coupled to said light means for selectively operating said light means to illuminate said at least one receiving aperture.

16. In combination with an electrical power strip having a generally elongated light non-permeable housing, a plurality of electrical light non-permeable power sockets mounted within said housing, each having at least one receiving aperture formed therethrough, and a cord which is operatively connected to each of said plurality of electrical power sockets and which is equipped with prongs for connecting said electrical power strip to supply voltage means, an improvement comprising a plurality of light sources each mounted within a respective power socket and operable upon supply of an operating voltage for illuminating at least one receiving aperture.

17. (canceled)

18. The improvement, according to claim 16, further comprising a control means coupled to said each light source and coupled to said supply voltage means for converting a supply voltage into said operating voltage.
